(19) United States
(12) Patent Application Publication
(10) Pub. No.: US 2012/0031747 A1
(43) Pub. Date: Feb. 9, 2012

(54) PROCESS AND SYSTEM FOR SEPARATING HEAVY AND LIGHT COMPONENTS CONTAINED IN A VAPOR MIXTURE

(75) Inventors: Rae Lynn Spencer, Cypress, TX (US); Gary W. LUCE, Spring, TX (US); John A. Spencer, Cypress, TX (US)

(73) Assignee: TERRABON MIX-ALCO, LLC, Houston, TX (US)

(21) Appl. No.: 13/198,269

(22) Filed: Aug. 4, 2011

Related U.S. Application Data
(60) Provisional application No. 61/370,484, filed on Aug. 4, 2010.

(51) Int. Cl. B01D 3/00

(52) U.S. Cl. 203/25

(57) ABSTRACT

Herein disclosed is a method of separating heavy and light components from a vapor mixture. The method comprises a. distilling the vapor mixture into a first vapor phase and a first liquid phase; and b. condensing at least a portion of the first vapor phase into a second liquid phase and a second vapor phase; wherein the distilling utilizes the internal energy of the vapor mixture. In an embodiment, the method further comprises c. utilizing at least a portion of the first liquid phase to absorb at least a portion of the second vapor phase. In some cases, the method further comprises cooling the at least a portion of the first liquid phase prior to utilizing it to absorb the at least a portion of the second vapor phase.

### CROSS-REFERENCE TO RELATED APPLICATIONS

This application claims the benefit under 35 U.S.C. §119(e) of U.S. Provisional Patent Application No. 61/370,484 filed Aug. 4, 2010, the disclosure of which is hereby incorporated herein by reference.

### FIELD OF THE INVENTION

The present invention generally relates to separation of heavy and light components contained in a vapor mixture. More particularly, the present invention relates to separation of heavy and light components contained in a vapor mixture according to the boiling point difference of such components utilizing the internal energy of the vapor mixture.

### BACKGROUND

In many processes, a vapor product stream containing light and heavy components is generated, which components need to be recovered or separated/purified. For instance, the MixAlco™ process produces intermediate carboxylate salts formed from carboxylic acids from carbon numbers of C2 up to C8 and higher. These salts include, for example, salts of calcium, sodium, potassium, or other ionic species. These carboxylate salts are crystallized and dried or concentrated into slurries. The salts are then input into a ketone reactor that operates at temperatures from about 300° C. to about 450° C. and pressures from about 15 inches of mercury vacuum up to about 2 psig with a salt residence time of about 5 to about 30 minutes. At the reactor conditions, the carboxylate salts decompose to ketone vapors of C3 to C15 carbon number and byproduct solid carbonate of the ionic species contained in the salts. Process yield to ketones is favored with longer solids residence time and shorter vapor product residence time. An inert gas (such as hydrogen, water/steam or carbon dioxide) can be introduced into the reactor to sweep the product organic vapors out of the reactor, thereby minimizing vapor residence time.

In traditional processes, the recovery method consists in immediately condensing the product vapor to liquid. Such operation results in the heat of condensation being rejected to utility cooling water. Furthermore, in situations where a sweep gas is used to aid in the removal of the vapor from the reaction zone, some of the light condensable products are carried through the condensation and lost, unless cryogenic temperatures are employed in the condenser, which is undesirable due to high costs. Moreover, in conventional processes, a distillation tower with an external reboiler (as an additional energy source) is needed to separate the condensed high molecular weight (MW) and low MW organic compounds and therefore increases the amount of energy needed in the separation process. In order to reduce the loss of low MW organic compounds, additional equipment and energy is often required to provide low temperature or even refrigerated condensation conditions.

For example, FIG. 1A schematically illustrates a currently-known process for separating ketones and other organic matters in a vapor product mixture. The vapor product mixture is often sent to a ketone separation tower for purification. The vapor stream S-1 from the ketone reactor is condensed at a temperature of 100 to 250° C. in quench condenser Q-2 and becomes stream S-2. Stream S-2 is further cooled to 35° C. in condenser E-2 to produce stream S-3 with all the heat of condensation rejected to cooling water. Condensed liquids in stream S-3 are collected in vessel D-2 and then pumped as stream S-4 to downstream processes or recycled as stream S-5 to quench condenser Q-2 as quenching liquid.

Vapors that are not condensed in Q-2 or E-2 are sent to the vent system as stream S-12. (In FIG. 1B, vapors that are not condensed in Q-2 or E-2 are sent to the vent system as stream S-6.) A water phase in D-2 is separated and pumped to recycle (S-10) and the products are sent to downstream conversion (S-11). Inert gases are sometimes introduced into the ketone reactor to minimize vapor residence time but have the detrimental effect of increasing the amount of light organic vapors that are not condensed which leave with the non-condensable gases to the vapor recovery system (stream S-12). Any organic vapors in stream S-12 are sent to a flare system and are therefore lost. Therefore, such know process has low process efficiency and yield.

As a result, there is continuing need and interest to develop methods and systems to efficiently and effectively separate light and heavy components contained in a vapor mixture.

### SUMMARY

Herein disclosed is a method of separating heavy and light components from a vapor mixture. The method comprises a. distilling the vapor mixture into a first vapor phase and a first liquid phase; and b. condensing at least a portion of the first vapor phase into a second liquid phase and a second vapor phase; wherein the distilling utilizes the internal energy of the vapor mixture. In an embodiment, the method further comprises c. utilizing at least a portion of the first liquid phase to absorb at least a portion of the second vapor phase. In some cases, the method further comprises cooling the at least a portion of the first liquid phase prior to utilizing it to absorb the at least a portion of the second vapor phase. In some embodiments, the method further comprises d. recycling the at least a portion of the first liquid phase after it absorbs the at least a portion of the second vapor phase to the distilling step. In an embodiment, the method further comprises condensing another portion of the first vapor phase into a reflux liquid to be recycled to the distilling step.

In an embodiment, distilling the vapor mixture takes place in a distillation column. In an embodiment, the method further comprises controlling the amount of the first vapor phase being condensed into a reflux liquid to control the temperature of the lower portion of the distillation column.

In an embodiment, the vapor mixture comprises more than one type of ketone. In an embodiment, the vapor mixture comprises more than one type of pyrolysis-generated gas component. In an embodiment, the vapor mixture comprises more than one type of Fischer-Tropsch-generated gas component. In an embodiment, the vapor mixture comprises more than one type of gas component generated in a biomass-to-liquid conversion process. In an embodiment, the vapor mixture comprises more than one type of gas component generated in a coal-to-liquid conversion process. In an embodiment, the vapor mixture comprises more than one type of gas component generated in a gas-to-liquid conversion process. In an embodiment, the vapor mixture comprises a non-reacting sweep gas. In some cases, the non-reacting sweep gas comprises nitrogen, hydrogen, steam, or carbon dioxide.

In an embodiment, the method further comprises collecting the first liquid phase. In an embodiment, distilling requires no additional heat input.

Also disclosed herein is a method of separating components contained in a vapor mixture having components of different boiling points, comprising a. distilling the vapor mixture into a first vapor phase and a first liquid phase; b. cooling at least a portion of the first vapor phase to produce a second liquid phase and a second vapor phase; and c. using at least a portion of the first liquid phase to absorb at least a portion of the second vapor phase; wherein the distilling utilizes the internal energy of the vapor mixture and requires no additional heat input.

In an embodiment, the method further comprises cooling the at least a portion of the first liquid phase prior to using it to absorb the at least a portion of the second vapor phase. In an embodiment, the method further comprises d. recycling the at least a portion of the first liquid phase after it absorbs the at least a portion of the second vapor phase to the distilling step. In an embodiment, the method further comprises condensing another portion of the first vapor phase into a reflux liquid to be recycled to the distilling step.

In some cases, the vapor mixture comprises more than one type of ketone. In some cases, the vapor mixture comprises more than one type of pyrolysis-generated gas component. In some cases, the vapor mixture comprises more than one type of Fischer-Tropsch-generated gas component. In some cases, the vapor mixture comprises more than one type of gas component generated in a biomass-to-liquid conversion process. In some cases, the vapor mixture comprises more than one type of gas component generated in a coal-to-liquid conversion process. In some cases, the vapor mixture comprises more than one type of gas component generated in a gas-to-liquid conversion process.

In an embodiment, the vapor mixture comprises a non-reacting sweep gas. In some cases, the non-reacting sweep gas comprises nitrogen, hydrogen, steam, or carbon dioxide.

In an embodiment, the method further comprises collecting the first liquid phase. In an embodiment, distilling requires no additional heat input.

Further disclosed herein is a system for separating heavy and light components from a vapor mixture. The system comprises a distillation column, wherein the distillation column is configured to produce a first vapor phase stream and a first liquid phase stream from the vapor mixture utilizing the internal energy of the vapor mixture; a condenser, wherein the condenser is configured to receive at least a portion of the first vapor phase stream from the distillation column and to produce a second vapor phase stream and a second liquid phase stream; and a vessel, wherein the vessel is configured to receive the first liquid phase stream from the distillation column.

In an embodiment, the system further comprises a partial condenser, wherein the partial condenser is configured to condense another portion of the first vapor phase stream into a reflux liquid stream and recycle the reflux liquid stream to the distillation column. In an embodiment, the system further comprises an absorption tower configured to receive the second vapor phase stream from the condenser; receive the first liquid phase stream from the distillation column; and allow the first liquid phase stream to interact with the second vapor phase stream to produce a third liquid phase stream and a third vapor phase stream. In some cases, the absorption tower is further configured to recycle the third liquid phase stream to the distillation column.

In an embodiment, the system further comprises a heat exchanger configured to receive and cool at least a portion of the first liquid phase stream; and send the cooled first liquid phase stream to the absorption tower. In an embodiment, the system further comprises another vessel configured to receive the second liquid phase stream from the condenser. In an embodiment, the distillation tower requires no additional heat input

In an embodiment, the method of this disclosure reduces the energy expended to separate high MW (molecular weight) products or organic compounds from low MW products or organic compounds. In an embodiment, the method of this disclosure also allows the separated high MW products or organic compounds to be cooled and used as an absorption fluid for recovery of light products or organic compounds from the non-condensable gas stream that would otherwise be lost to vapor recovery where it would be used as fuel or burned in a flare. Both of them utilize the energy contained in the vapors entering the system.

In an embodiment, the method of this disclosure allows the crude distillation of higher MW from the lower MW compounds utilizing the heat of the incoming vapors, thus minimizing any additional energy required to heat the tower.

If the feed reactor generating the multi-component vapors requires an inert gas purge to sweep the product organic vapors from the reactor, the addition of the inert sweep gas increases the amount of light organic compounds that are carried out with non-condensable gases in the condensers (stream S-12 in FIG. 1A) which results in both yield loss and process inefficiency. In an embodiment, the method of this disclosure utilizes the high MW compounds that are separated in the previously mentioned distillation tower as an absorption fluid to absorb the low MW organic compounds from the non-condensable gases and avoid losses. The recovered low MW compounds as well as the high MW compounds are then returned back to the previously mentioned distillation tower for recovery thereby increasing process yield and efficiency.

The problem before the method of this disclosure required installation of a distillation tower with a larger external energy source/reboiler to separate the condensed high and low MW organic compounds. This increased the amount of energy needed in the process.

Before the method of this disclosure reduction of the amount of low MW organics lost with the non-condensable vapors required additional equipment and energy cost to utilize very low temperature refrigerated condensation.

Before the method of this disclosure absorption of valuable light organic compounds from the non-condensable vapors would have required selection of a suitable low volatility soluble hydrocarbon that absorbs ketones. This solvent would have to be chemically inert with the absorbed vapors and of low enough volatility so the recovered organic compounds could be vaporized from the solvent. This process would have required an additional separation tower to recover solvent resulting in additional capital cost to the process.

In an embodiment, the method of this disclosure reduces the amount of energy that would have to be added to separate high and low MW organic compounds that are contained in a superheated multi-component vapor stream. It achieves this by utilizing the level of superheat and the heat of condensation of the high MW organic compounds that are generated upstream (in our example, they are generated in the ketone reactor). The method of this disclosure uses that heat for the driving energy in a distillation tower whereas this energy would normally be lost in cooling water heat rejection.

In an embodiment, the method of this disclosure also reduces the amount of light (lower MW) organic compounds that would be lost as yield when using an inert gas purge stream. It achieves this by using the separated high MW organic compounds as an absorption fluid to absorb the light MW compounds from the inert gas purge stream and return them for recovery back to the process. Normally this separation would require expensive refrigeration and energy.

In an embodiment, the method of this disclosure also reduces process capital costs in that a separate absorbent liquid and separate absorbent recovery tower are avoided since the high boiling product is used as an absorbent. In addition no high boiling product is lost in the process of using it as an absorption fluid.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a more detailed description of the preferred embodiment of the present invention, reference will now be made to the accompanying drawings, wherein:

FIG. 1A schematically illustrates a currently-known process (prior art process) for separating ketones and other organic matters in a vapor mixture.

FIG. 1B is a variation of the prior art process as shown in FIG. 1A.

FIG. 2A is a schematic process flow diagram illustrating a process for separating heavy and light components from a ketone vapor mixture in accordance with an embodiment of this disclosure.

FIG. 2B is a variation of an improved separation process, in accordance with an embodiment of this disclosure.

### NOTATION AND NOMENCLATURE

In a general sense, the internal energy of a thermodynamic system, or a body with well-defined boundaries, denoted by U, or sometimes E, is the total of the kinetic energy due to the motion of particles (translational, rotational, vibrational) and the potential energy associated with the vibrational and electric energy of atoms within molecules or crystals. It includes the energy in all of the chemical bonds, and the energy of the free, conduction electrons in metals. Internal energy does not include the translational or rotational kinetic energy of a body as a whole. It excludes any potential energy a body may have because of its location in external gravitational or electrostatic field. Internal energy is also called intrinsic energy. In this disclosure, the internal energy of a vapor mixture refers to the total of the kinetic energy due to the motion of particles (translational, rotational, vibrational) and the potential energy associated with the vibrational and electric energy of atoms within molecules contained in the vapor mixture.

In this disclosure, light and heavy components are categorized in a relative sense according to their boiling points. For a particular vapor mixture, light components generally refer to substances that have lower boiling points than heavy components. At a given pressure, higher molecular weight (MW) substances generally have higher boiling points than lower MW substances, especially when the higher MW and lower MW substances belong to the same chemical family (e.g., ketone family, alcohol family).

Certain terms are used throughout the following description and claims to refer to particular system components. This document does not intend to distinguish between components that differ in name but not function.

In the following description and in the claims, the terms “including” and “comprising” are used in an open-ended fashion, and thus should be interpreted to mean “including, but not limited to . . . ”.

### DETAILED DESCRIPTION

Overview. Some embodiments of this disclosure utilize the heat that would be lost in condensation as the heat source for distillation/separation of the light and heavy components into high molecular weight (MW) and low MW component streams. Some embodiments of this disclosure utilize the high MW component stream as a lean absorption liquid in a light component recovery absorption tower to improve process efficiency. In some embodiments, the light-component-rich-high-MW-component stream is returned back to the lights/heavies separation distillation tower. The benefits of the disclosed process are improved energy utilization and improved product recovery. Note that although the process illustrated here uses the products from a ketonization process that employs thermal conversion of a mixture of carboxylate salts, this is intended only as a example and it should not be limiting. Hot vapors that can be processed using the methodology described herein are generated in many processes throughout industry (e.g., biomass pyrolytic conversions, Fischer-Tropsch conversions, and other Biomass-, coal- or gas-to-liquid thermal conversion processes).

In some embodiments, the vapor mixture comprises more than one type of ketone. In some embodiments, the vapor mixture comprises more than one type of pyrolysis-generated gas component. In some embodiments, the vapor mixture comprises more than one type of Fischer-Tropsch-generated gas component. In some embodiments, the vapor mixture comprises more than one type of gas component generated in a biomass-to-liquid conversion process. In some embodiments, the vapor mixture comprises more than one type of gas component generated in a coal-to-liquid conversion process. In some embodiments, the vapor mixture comprises more than one type of gas component generated in a gas-to-liquid conversion process. In some embodiments, the vapor mixture comprises a non-reacting (inert) sweep gas. In some cases, the non-reacting (inert) sweep gas comprises nitrogen, hydrogen, steam, or carbon dioxide.

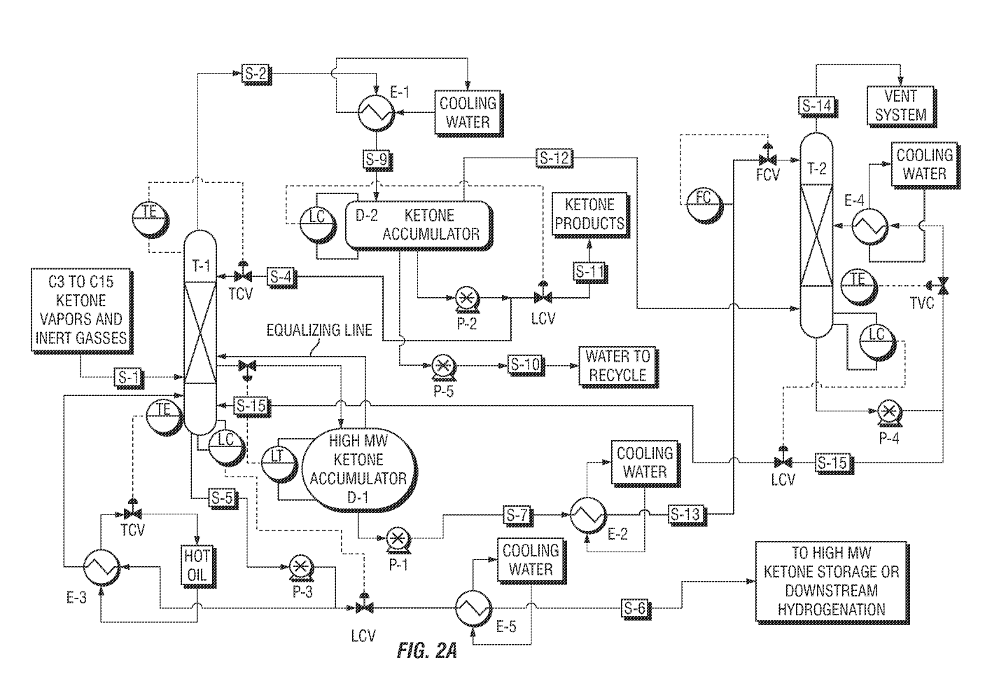

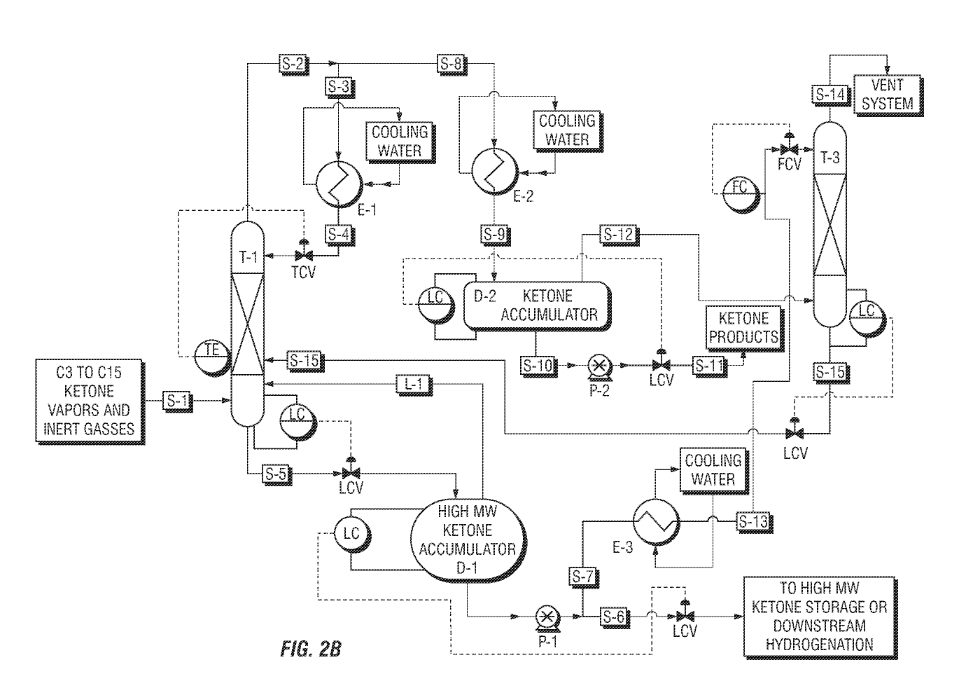

In an embodiment, as illustrated in FIG. 2A, a process for separating heavy and light components from a ketone vapor mixture, as an example, comprises distilling the vapor mixture into a first vapor phase and a first liquid phase; condensing at least a portion of the first vapor phase into a second liquid phase and a second vapor phase; and utilizing at least a portion of the first liquid phase to absorb at least a portion of the second vapor phase. The details of this process are described hereinbelow.

As an example, a vapor stream (Stream S-1, comprising e.g., C3-C15 ketone vapors and inert gases) from a ketone reactor is sent to the bottom of distillation tower T-1 where it is cooled and condensed at liquid-gas equilibrium conditions with both liquid and vapor present in the tower. A recovered ketone stream from Tower T-2 also enters the bottom of Tower T-1 (Stream S-15). Vapor from the top of T-1 (Stream S-2) enters partial Condenser E-1 where vapors are condensed and collected in Accumulator D-2. If water is present in the ketone reactor in sufficient quantities, both aqueous and organic liquid phases may be present in the condensed liquids. Condensed organic phase liquids are sent back via Pump P-2 to the top stage of T-1 as reflux (Stream S-4) with the balance sent to storage or downstream processes (Stream S-11).

Aqueous phase liquid (Stream S-10) with some dissolved light ketones are sent to a light ketone recovery process. Non-condensed vapors consisting of inert gases and light ketones and organic compounds (Stream S-12) are sent to the bottom of Absorber Tower T-2. High boiling ketones and high molecular weight (MW) organic compounds are separated and leave Tower T-1 as bottoms liquid (Stream S-5) or as a sidedraw liquid to Accumulator D-1.

The bottoms of Tower T-1 (stream S-5) is sent via pump P-3 to high MW ketone storage (Stream S-6) or to Trim Reboiler E-3. E-3 supplies supplemental duty when the incoming feed vapors (Steam S-1) do not contain sufficient heat to drive the total required tower heat duty. The sidedraw high MW ketones collected in Accumulator D-1 are pumped via P-1 to Cooler E-2 before they are sent to Absorber Tower T-2 (Stream S-13).

To summarize, as a result of the above-mentioned design, Tower T-1 is used as a rectifying distillation tower that separates incoming vapors from the ketone reaction (the upstream process) and recovery tower (Tower T-2) into four streams:
1) A bottoms stream (S-6) consisting of high boiling ketones and organic compounds.
2) A sidedraw stream (S-7) of mid boiling ketones and organic compounds.
3) A condensed distillate product ketone and organic compound liquid stream (S-11).
4) A lights stream (S-12) of ketones and organic and non-organic compounds that are not condensed in E-1.

Heat for the rectification is supplied by the desuperheating of the incoming vapors from the upstream process as well as the heat of the subsequent condensation of the high MW organic compounds that are quenched upon entry to the tower. Reboiler E-3 supplies additional heating duty if required.

Tower T-2 (FIG. 2A) is used to absorb and recover light ketones and organic compounds that were not condensed in E-1. The sidedraw stream (S-7) from Tower T-1 is used as a lean absoption liquid to strip and recover light ketones and organic compounds from the non-condensable gases from Exchanger E-1.

The high-boiling-point organic compounds from pump P-1 (Stream S-7) are cooled in Exchanger E-2 (Stream S-13) and sent to the top stage of Absorber Tower T-2. Vapors not condensed in E-1 (stream S-12) enter the bottom stage of Tower T-2. Tower T-2 contains either trays or packing to use the cooled high-MW ketone stream (S-13) to absorb light organic compounds from the non-condensable gases entering from accumulator D-2. Non-condensable gases stripped of most organic compounds leave the top of tower T-2 and are sent to vented vapor treatment. Higher-MW organic compounds with absorbed light organic compounds exit the bottom of tower T-2 (S-15) and are sent to the bottom of tower T-1 to be recovered as liquid product. Tower T-2 also has a bottoms recirculation cooler (E-4) to remove the heat of absorption from the recovered ketone vapors. As a result of utilizing Tower T-2 and using high-molecular-weight ketones as a low volatility absorption liquid, light ketone vapors in Stream S-12, that would normally be lost or used for fuel value, are recovered as product.

In an embodiment, as illustrated in FIG. 2B, a process for separating heavy and light components from a ketone vapor mixture comprises distilling the vapor mixture into a first vapor phase and a first liquid phase; condensing at least a portion of the first vapor phase into a second liquid phase and a second vapor phase; and utilizing at least a portion of the first liquid phase to absorb at least a portion of the second vapor phase. The details of this process are described hereinbelow.

As an example, a vapor stream (Stream S-1, comprising e.g., C3-C15 ketone vapors and inert gases) from a ketone reactor is sent to the bottom of distillation tower T-1 where it is cooled and condensed at liquid-gas equilibrium conditions with both liquid and vapor present in the tower.

Part of the vapor phase from the top of T-1 (Stream S-2) is sent to partial condenser E-1 as Stream S-3 and part of Stream S-2 continues on as vapor stream S-8 to condenser E-2. Condensed liquid from E-1 is recycled to the top stage of T-1 as reflux (Stream S-4) via, for example, a temperature control valve (TCV). Condensed liquid from E-2 is collected in ketone accumulator D-2.

The vapor phase in D-2 comprising light (more volatile) components (e.g., inert gases, light ketones and organic and non-compounds) is sent as Stream S-12 to the bottom of Absorber Tower T-3. The liquid phase in D-2 comprising heavy (less volatile) components (e.g., condensed ketones and organic compounds) is pumped as Stream S-10 via Pump P-2 and via a level control valve (LCV) as Stream S-11 to storage or downstream processes as ketone products.

Heavy components (e.g., less volatile ketones and organic compounds) leave Tower T-1 as bottoms liquid (Stream S-5) and drain to high molecular-weight (MW) ketone accumulator D-1 via a LCV. Line L-1 is a pressure equalizing line, ensuring that liquid stream S-5 is able to drain from T-1 to D-1. Alternatively, equalizing line L-1 is omitted and a pump is used to pump liquid stream S-5 from T-1 to D-1. The liquid phase in D-1 is sent via Pump P-1 as Stream S-6 to high-MW ketone storage or downstream processes (e.g., hydrogenation) or sent as Stream S-7 to Cooler E-3.

The amount of vapor condensed in E-1 is used to control the temperature of the lower portion of Tower T-1. As a result of this design, Tower T-1 is used as a rectifying distillation tower that separates higher molecular weight organic compounds from the lower molecular weight organic compounds that are not condensed in E-1. Heat for such rectification is supplied by the desuperheating of the incoming vapor as well as heat of condensation of the heavy components (e.g., higher MW ketones and organic compounds) that are quenched upon entering the tower.

Liquid Stream S-7, comprising heavy components (e.g., higher-boiling-point organic compounds) from Pump P-1, is cooled in Heat Exchanger E-3 to become Stream S-13 and sent to the top stage of Absorber Tower T-3 via a flow control valve (FCV). The vapor phase from D-2 (comprising components that are not condensed in E-2) enters the bottom stage of Tower T-3 as Stream S-12. Tower T-3 comprising either trays or packing utilizes the cooled Liquid Stream S-13 comprising heavy components to absorb the vapor phase from D-2 comprising light components. Gases/vapors that are not condensed or absorbed leave the top of Tower T-3 as Stream S-14 and are sent to, for example, a vent system. Most organic compounds (comprising higher-MW organic compounds and absorbed light organic compounds) are condensed or absorbed into the liquid phase in Tower T-3 and exit the bottom of T-3 as Stream S-15. Stream S-15 is then sent to the bottom of Tower T-1 via a LCV.

In FIGS. 2A and 2B the location of all the instrumentation and control system is only shown as an illustration and it is not intended to be limiting. The control methods and instruments (for e.g., temperatures, pressures, flows and levels) are know to one skilled in the art and the location, arrangement, and purpose of such control methods/instruments are not intended to be limiting in any way. There are many different options on how to control temperatures, pressures, flows and levels in chemical processing equipment what is shown here is only plausible illustrative scenario. For instance, in FIG. 2B, the temperature control valve (TCV) for T-1 is connected with or coupled to a temperature element (TE) to fulfill its function of controlling the temperature of the lower portion of T-1. The level control valves (LCV) for T-1, T-3, D-1, and D-2 are connected with or coupled to level controllers (LC) to fulfill the function of controlling the liquid level in T-1, T-3, D-1, and D-2, respectively. The flow control valve (FCV) for S-13 is connected with or coupled to a flow controller (FC) to regulate the flow rate of stream S-13 into Tower T-3.

Advantages. In some embodiments of this disclosure, higher MW (heavy) components are separated from lower MW (light) components contained in a vapor mixture. In some embodiments, no or very little additional energy is needed for the separation of heavy and light components in a vapor mixture. In some embodiments, the separated heavy components are cooled and used as an absorption liquid for recovery of the light components (comprising, for example, organic compounds and inert gases), which in conventional processes are often lost or recovered by using expensive low temperature or refrigeration conditions, making the instant method more effective and efficient. In some embodiment, the separation of heavy and light components and the more efficient recovery of light components are both accomplished. In various embodiments, the separation of heavy and light components and the more efficient recovery of light components utilize the internal energy contained in the vapor mixture entering the separation system with no or little additional energy.

In some embodiments, the energy needed to separate heavy and light components contained in a vapor mixture is from the superheat and the heat of condensation of the high MW organic compounds in the vapor mixture. For example, such heat is the driving force/energy in a distillation tower; whereas such energy is conventionally lost in cooling water heat rejection.

In some embodiments, the method described herein allows the crude distillation/separation of higher MW compounds from the lower MW compounds utilizing the heat of the incoming vapors, thus requiring little additional energy.

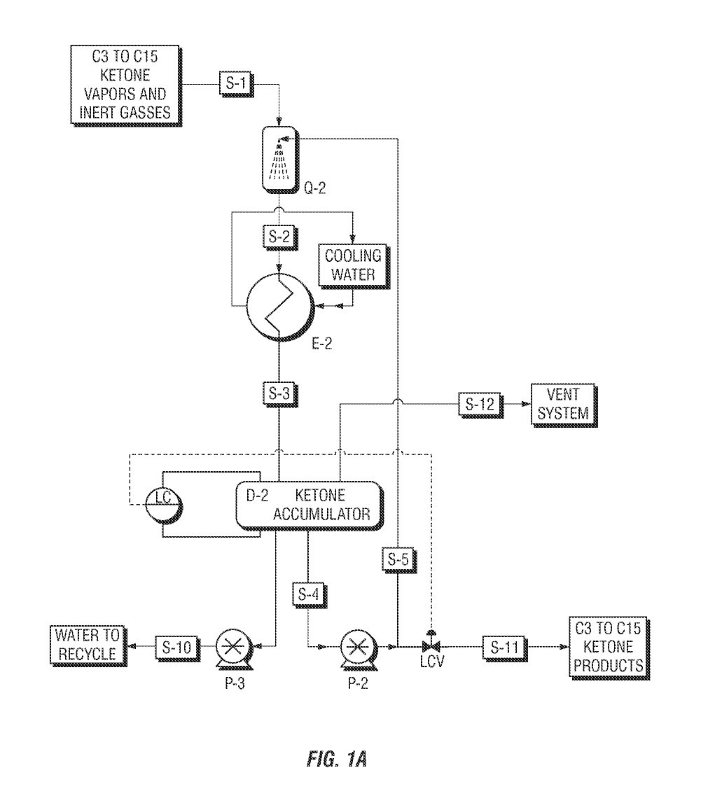

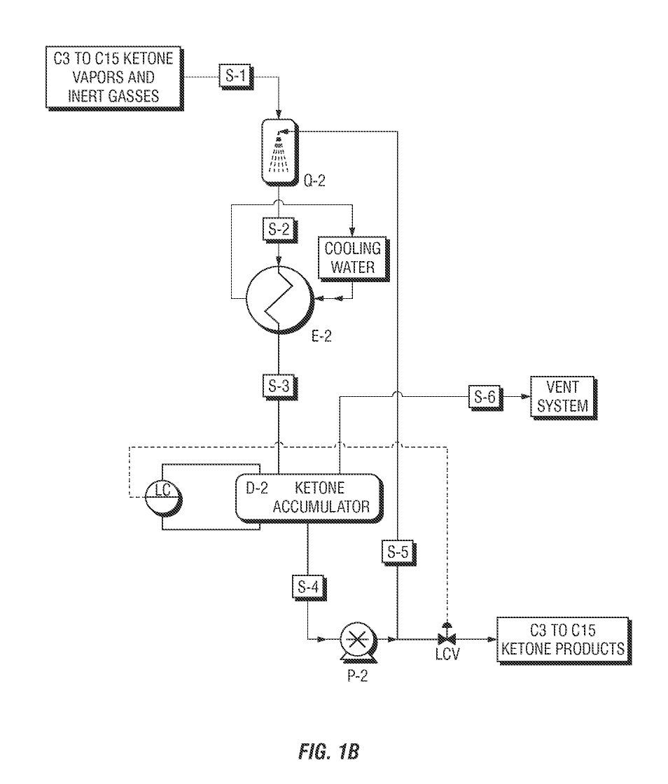

In some embodiments, if the reaction generating the multi-component vapor (e.g., ketonization of carboxylate salts) requires an inert gas purge to sweep the organic products in the vapor phase from the reactor, the process disclosed herein reduces the loss of light components compared to conventional processes (such as the one shown in FIGS. 1A and 1B).

In some embodiments, the higher-MW compounds are separated from lower MW compounds in a distillation tower as liquids and then used to absorb the lower MW compounds. In some embodiments, the recovered lower MW compounds as well as the higher MW compounds are recycled to the distillation tower for further separation and recovery, thereby increasing process yield and efficiency.

Before what is disclosed herein, absorption of valuable light organic compounds from the non-condensable vapors would have required selection a suitable low volatility soluble hydrocarbon that could absorb the low-boiling-point compounds (illustrated here as low molecular-weight ketones). This solvent would have to be chemically inert with the absorbed vapors and of low enough volatility so the recovered organic compounds could be vaporized from the solvent. This process would have required an additional separation tower to recover solvent resulting in additional capital cost to the process.

The method of this disclosure also reduces process capital costs in that a separate absorbent liquid and separate absorbent recovery tower are avoided since the high boiling product is used as an absorbent. In addition no high-boiling product is lost in the process of using it as an absorption fluid.

In various embodiments, the method of this disclosure utilizes the internal energy of the vapor phase. Furthermore, the method of this disclosure utilizes the liquid phase produced during the process as the source of the absorption liquid. In certain embodiments, the method of this disclosure utilizes the internal energy of the vapor phase and utilizes the liquid phase produced during the process as the source of the absorption liquid. In some further embodiments, the method of this disclosure uses the condensing energy to drive the distillation process.

The system and method as described above may be utilized for recovery of any condensable multi-component vapor(s), for example, in the MixAlco™ ketonization process. The system and method as illustrated in FIG. 2A are not intended to be limiting in any fashion.

### EXAMPLES

### Example 1

To illustrate the energy and product recovery benefits of this disclosure, a simulation of the processes shown in FIGS. 1 and 2, using Honeywell Unisim simulation package, is performed in the following three cases:

Case 1 (comparative): Fully condensed ketone stream shown in FIG. 1A is fed to Tower T-1 shown in FIG. 2A with no Absorber Tower T-2.

Case 2 (comparative): Fully condensed ketone stream shown in FIG. 1A is fed to Tower T-1 shown in FIG. 2A with light ketones recovered in Absorber Tower T-2.

Case 3: A fully uncondensed ketone vapor stream direct from the ketone reactor upstream is fed to Tower T-1 shown in FIG. 2A with light ketones recovered in Absorber Tower T-2.

Table 1 shows the results of the above simulations, which demonstrate the improvements of the method of this disclosure.

TABLE 1
Ketone Distillation Separation Scenarios

| | Case 1 | Case 2 | Case 3 |
|---|---|---|---|
| Ketones fed to tower T-1 | 5,000 | 5,000 | 5,000 |
| lb/hr | | | |
| Tower T-1 Reboiler | 2,040,000 | 2,690,000 | 677,000 |
| Duty E-3 BTU/hr | | | |
| Tower T-1 Condenser | 1,970,000 | 2,470,000 | 2,660,000 |
| Duty E-1 BTU/hr | | | |
| Ketone losses to vent | 97.61 | 0.05 | 0.05 |
| system lb/hr | | | |
| Ketone losses to vent | 1.95 | 0.001 | 0.001 |
| system % of total feed | | | |
| Reboiler energy | | 650,000 | −1,363,000 |
| reduction from case 1 | | | |
| Coundenser energy | | 500,000 | 690,000 |
| reduction from case 1 | | | |
| Ketones recovered | | 97.56 | 97.56 |
| compared to case 1 | | | |

As it can be seen, the improvement of ketones being fed as vapors (Case 3) reduced total energy consumption of the system by 1.363 MM BTU/hr to ˜135 BTUs per pound of ketone fed (˜67% reduction in energy consumption) when compared with Case 1. The addition of Tower T-2 absorption system reduced product ketone losses from ˜2% of the feed to basically 0. In addition, using the product high-MW products as the absorption fluid to recover light organic vapors eliminates the need for a separate absorption fluid that could be introduced as a product contaminant.

While preferred embodiments of the invention have been shown and described, modifications thereof can be made by one skilled in the art without departing from the spirit and teachings of the invention. The embodiments described herein are some only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, and so forth). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The disclosures of all patents, patent applications, and publications cited herein are hereby incorporated by reference, to the extent they provide some, procedural or other details supplementary to those set forth herein.

What is claimed is:

1. A method of separating heavy and light components from a vapor mixture, comprising
a. distilling the vapor mixture into a first vapor phase and a first liquid phase; and
b. condensing at least a portion of the first vapor phase into a second liquid phase and a second vapor phase;
wherein said distilling utilizes the internal energy of said vapor mixture.

2. The method of claim 1 further comprising
c. utilizing at least a portion of the first liquid phase to absorb at least a portion of the second vapor phase.

3. The method of claim 2 further comprising cooling the at least a portion of the first liquid phase prior to utilizing it to absorb the at least a portion of the second vapor phase.

4. The method of claim 1 further comprising
d. recycling the at least a portion of the first liquid phase after it absorbs the at least a portion of the second vapor phase to the distilling step.

5. The method of claim 1 further comprising condensing another portion of the first vapor phase into a reflux liquid to be recycled to the distilling step.

6. The method of claim 1 wherein distilling the vapor mixture takes place in a distillation column.

7. The method of claim 6 further comprising controlling the amount of the first vapor phase being condensed into a reflux liquid to control the temperature of the lower portion of the distillation column.

8. The method of claim 1 wherein said vapor mixture comprises more than one type of ketone.

9. The method of claim 1 wherein said vapor mixture comprises more than one type of pyrolysis-generated gas component.

10. The method of claim 1 wherein said vapor mixture comprises more than one type of Fischer-Tropsch-generated gas component.

11. The method of claim 1 wherein said vapor mixture comprises more than one type of gas component generated in a biomass-to-liquid conversion process.

12. The method of claim 1 wherein said vapor mixture comprises more than one type of gas component generated in a coal-to-liquid conversion process.

13. The method of claim 1 wherein said vapor mixture comprises more than one type of gas component generated in a gas-to-liquid conversion process.

14. The method of claim 1 wherein said vapor mixture comprises a non-reacting sweep gas.

15. The method of claim 14 wherein said non-reacting sweep gas comprises nitrogen, hydrogen, steam, or carbon dioxide.

16. The method of claim 1 further comprising collecting said first liquid phase.

17. The method of claim 1 wherein said distilling requires no additional heat input.

18. A method of separating components contained in a vapor mixture having components of different boiling points, comprising
a. distilling the vapor mixture into a first vapor phase and a first liquid phase;
b. cooling at least a portion of the first vapor phase to produce a second liquid phase and a second vapor phase; and
c. using at least a portion of the first liquid phase to absorb at least a portion of the second vapor phase;
wherein said distilling utilizes the internal energy of said vapor mixture and requires no additional heat input.

19. The method of claim 18 further comprising cooling the at least a portion of the first liquid phase prior to using it to absorb the at least a portion of the second vapor phase.

20. The method of claim 18 further comprising
d. recycling the at least a portion of the first liquid phase after it absorbs the at least a portion of the second vapor phase to the distilling step.
